(19) United States
(12) Patent Application Publication
(10) Pub. No.: US 2009/0164997 A1
(43) Pub. Date: Jun. 25, 2009

(54) SYSTEM AND METHOD FOR PROCESSING WORKFLOW TASKS

(75) Inventors: Chung-I Lee, Taipei Hsien (TW); Xin-Yu Huang, Shenzhen City (CN); Dong-Wei Jin, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/248,005

(22) Filed: Oct. 8, 2008

(30) Foreign Application Priority Data
Dec. 25, 2007 (CN) 200710203392.1

(51) Int. Cl. G06F 9/46

(52) U.S. Cl. 718/100

(57) ABSTRACT

A computer-implemented method for processing workflow tasks is disclosed. The method includes receiving a user operation to start a task, determining if the user operation starts a new task according to a task status table, obtaining a version number of a task processing program from a configuration file or the task status table according to a determined result. The method further includes sending the version number to a task processing server, the task processing server comprising one or more task processing programs with different version numbers, loading the task processing program for processing the user operation according to the version number, recording processed results, and storing the processed results in the task status table.

### BACKGROUND

1. Field of the Invention

Embodiments of the present disclosure relate to systems and methods for software development, and particularly to a system and method for processing workflow tasks.

2. Description of Related Art

Authorization tasks are very common and frequent tasks in a workplace. Each task has a specified workflow, which is a depiction of a sequence of operations, declared as work of a person, work of a simple or complex mechanism, work of a group of persons, work of an organization, or machines. For example, a typical workflow of a task for authorizing a document may include: obtaining the document from a sponsor, determining the number of authorizers, delivering the document from one authorizer to another for authorization, and lastly, informing the sponsor of the authorization information.

In a normal workflow management software, each step (regarded as a work item) in a task can be processed using a computer so as to reduce manual work and improve process efficiency. However, if the workflow of a task has been changed, the previous version of a workflow management software cannot be used until a new version of the workflow management software is programmed, and the previous version of the workflow management software is covered by the new version of the workflow management software.

What is needed, therefore, is an improved system and method for processing workflow tasks.

### SUMMARY

A computer-implemented method for processing workflow tasks is provided. The method includes: receiving a user operation to start a task, wherein the task comprises one or more steps; determining if the user operation starts a new task according to a task status table, wherein the task status table comprises a current step in a workflow of the task, a task processing program for processing the task, and a version number of the task processing program; obtaining the version number of the task processing program from a configuration file if the user operation starts the new task, or obtaining the version number of the task processing program from the task status table if the user operation does not start the new task; sending the version number to a task processing server, the task processing server comprising one or more task processing programs with different version numbers; loading the task processing program for processing the user operation according to the received version number by the task processing server; recording processed results of the task processing program, and storing the processed results in the task status table.

Other systems, methods, features, and advantages of the present disclosure will become apparent to one with skill in the art upon examination of the following drawings and detailed description.

### BRIEF DESCRIPTION OF THE DRAWINGS

FIG. 1 is a schematic diagram of one embodiment of a system for processing workflow tasks;

FIG. 2 is a block diagram of one embodiment of a system for processing workflow tasks; and

FIG. 3 is a flowchart of one embodiment of a method for processing workflow tasks.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

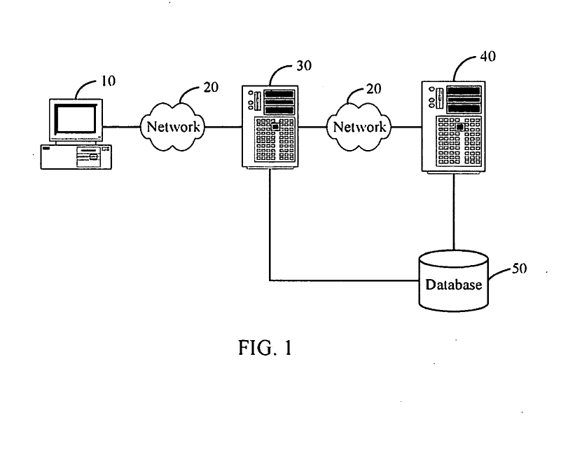

FIG. 1 is a schematic diagram of one embodiment of a system for processing workflow tasks. In one embodiment, the system includes a client computer 10, a web server 30, a task processing server 40, and a database system 50. The web server 30 is connected to the client computer 10 and the task processing server 40 through a network 20. The web server 30 and the task processing server 40 are connected with the database system 50 through a database connectivity. The database connectivity may be an open database connectivity (ODBC) or a Java database connectivity (JDBC) depending on the embodiment.

The database system 50 is configured for storing a task table and a task status table. In one embodiment, the task table is configured for storing a task identifier (ID) and one or more work items in a workflow of a task, wherein a work item represents a step in the workflow of the task. The task includes one or more steps to be processed in sequence. For example, a typical workflow of a task for authorizing a document may include the following steps: obtaining the document from a sponsor, determining the number of authorizers, delivering the document from one authorizer to another for authorization, and lastly, informing the sponsor of the authorization information. The task status table is configured for storing a current step in a workflow of a task, a task processing program for processing the task, and a version number of the task processing program. The database system 50 stores the task table and the task status table into a storage system. Depending on the embodiment, the storage system may be a hard disk drive, a Read Only Memory (ROM), or other forms of storage mediums.

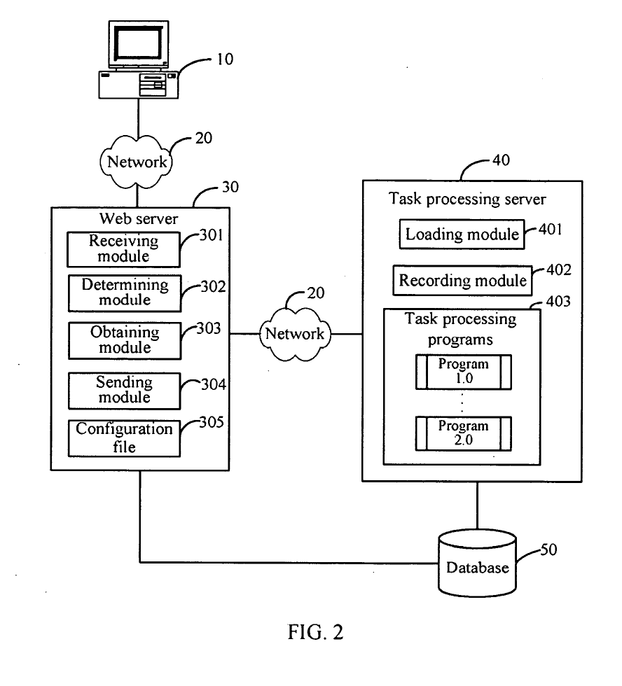

FIG. 2 is a block diagram of one embodiment of a system for processing workflow tasks. In one embodiment, the web server 30 may include a receiving module 301, a determining module 302, an obtaining module 303, a sending module 304, and a configuration file 305. The task processing server 40 may include a loading module 401, a recording module 402, and one or more task processing programs 403 having different version numbers (such as 1.0 and 2.0).

The receiving module 301 is configured for receiving a user operation sent from the client computer 10 to start a step in a task, wherein the task comprises one or more steps to be processed in sequence. The user operations may include, for example, obtaining a document from a sponsor or delivering a document from one authorizer to another authorizer for authorization.

The determining module 302 is configured for determining if the user operation starts a new task according to the task status table in the database system 50. If the user operation is a first step in the task status table, the determining module 302 determines the user operation starts the new task, otherwise, the determining module 302 determines the user operation does not start the new task.

The obtaining module 303 is configured for obtaining a version number of a task processing program from the configuration file 305 if the user operation starts the new task, or obtaining the version number of the task processing program from the task status table if the user operation does not start the new task. The configuration file 305 is configured for storing a latest version number of the task processing program. The new version number of a task processing program increases linearly, for example from 1.0 to 2.0 where 2.0 is a newer version than 1.0.

The sending module 304 is configured for sending the version number to the task processing server 40.

The loading module 401 is configured for loading the task processing program for processing the user operation according to the received version number by the task processing server 40.

The recording module 402 is configured for recording processed results of the task processing program, and storing the processed results in the task status table. The processed results may include: the current step in a workflow of the task, the task processing program for processing the task, and the version number of the task processing program.

The obtaining module 303 is further configured for obtaining the version number of the task processing program from the configuration file 305 without determining if the user operation starts the new task.

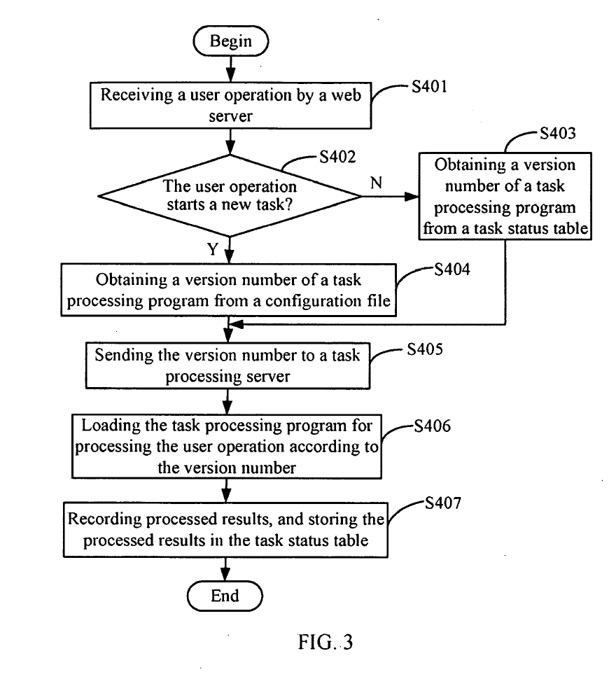

FIG. 3 is a flowchart of one embodiment of a method for processing workflow tasks. Depending on the embodiment, additional blocks may be added, others removed, and the ordering of the blocks may be changed.

In block S401, the receiving module 301 receives a user operation sent from the client computer 10 to start a step in a task, wherein the task comprises one or more steps to be processed in sequence.

In block S402, the determining module 302 determines if the user operation starts a new task according to a task status table in the database system 50, wherein the task status table comprises a current step in a workflow of a task, a task processing program for processing the task, and a version number of the task processing program. If the user operation is a first step in the task status table, the determining module 302 determines the user operation starts the new task, the procedure goes to block S404, otherwise, the determining module 302 determines the user operation does not start the new task, and the procedure goes to block S403.

In block S403, the obtaining module 303 obtains the version number of the task processing program from the task status table, then the procedure goes to block S405.

In block S404, the obtaining module 303 obtains the version number of the task processing program from the configuration file 305, then the procedure goes to block S405. The configuration file 305 is configured for storing a latest version number of the task processing program.

In block S405, the sending module 304 sends the version number to the task processing server 40.

In block S406, the loading module 401 loads the task processing program for processing the user operation according to the received version number by the task processing server 40.

In block S407, the recording module 402 records processed results of the task processing program, and storing the processed results in the task status table. The processed results may include: the current step in a workflow of the task, the task processing program for processing the task, and the version number of the task processing program.

In other embodiments, the block S402 and the block S403 can be removed, in other words, the obtaining module 303 obtains the version number of the task processing program from the configuration file 305 without determining if the user operation starts the new task.

It should be emphasized that the above-described embodiments of the present disclosure, particularly, any preferred embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for processing workflow tasks, the method comprising:
receiving a user operation to start a task, wherein the task comprises one or more steps;
determining if the user operation starts a new task according to a task status table, wherein the task status table comprises a current step in a workflow of the task, a task processing program for processing the task, and a version number of the task processing program;
obtaining the version number of the task processing program from a configuration file if the user operation starts the new task, or obtaining the version number of the task processing program from the task status table if the user operation does not start the new task;
sending the version number to a task processing server, the task processing server comprising one or more task processing programs with different version numbers;
loading the task processing program for processing the user operation according to the received version number by the task processing server; and
recording processed results of the task processing program, and storing the processed results in the task status table.

2. The method according to claim 1, wherein the block of determining if the user operation starts a new task comprises: determining the user operation starts the new task if the user operation is a first step in the task status table, or determining the user operation does not start the new task if the user operation is not the first step in the task status table.

3. The method according to claim 1, wherein the processed results comprise: the current step in a workflow of a task, the task processing program for processing the task, and the version number of the task processing program.

4. A computer-implemented method for processing workflow tasks, the method comprising:
receiving a user operation to start a task, wherein the task comprises one or more steps;
obtaining a version number of a task processing program from a configuration file;
sending the version number to a task processing server, the task processing server comprising one or more task processing programs with different version numbers;
loading the task processing program for processing the user operation according to the received version number by the task processing server; and
recording processed results of the task processing program, and storing the processed results in the task status table.

5. A computing system for processing workflow tasks comprising:
a client computer;
a web server;
a task processing server;
a database, wherein the web server is connected to the client computer and the task processing server, the database is connected to the web server and the task processing server, the web server comprising a receiving module, a determining module, an obtaining module, a sending module, and a configuration file, the task processing server comprising a loading module, a recording module, and one or more task processing programs with different version numbers, wherein:
the receiving module is configured for receiving a user operation sent from the client computer to start a task, wherein the task comprises one or more steps;
the determining module is configured for determining if the user operation starts a new task according to a task status table in the database, wherein the task status table comprises a current step in a workflow of the task, a task processing program for processing the task, and a version number of the task processing program;
the obtaining module is configured for obtaining the version number of the task processing program from the configuration file if the user operation starts the new task, or obtaining the version number of the task processing program from the task status table if the user operation does not start the new task;
the sending module is configured for sending the version number to a task processing server;
the loading module is configured for loading the task processing program for processing the user operation according to the received version number by the task processing server; and
the recording module is configured for recording processed results of the task processing program, and storing the processed results in the task status table.

6. The system according to claim 5, wherein the determining module determines if the user operation starts a new task comprises: the determining module determines the user operation starts the new task if the user operation is a first step in the task status table, or determines the user operation does not start the new task if the user operation is not the first step in the task status table.

7. The system according to claim 5, wherein the processed results comprise: the current step in a workflow of a task, the task processing program for processing the task, and the version number of the task processing program.
